(19) United States
(12) Patent Application Publication
(10) Pub. No.: US 2022/0196401 A1
(43) Pub. Date: Jun. 23, 2022

(54) PRESSURE CHANGE COMPENSATION FOR ELEVATION POSITIONING

(71) Applicant: HERE Global B.V., Eindhoven (NL)

(72) Inventors: Lauri Aarne Johannes Wirola, Tampere (FI); Henri Nurminen, Tampere (FI); Pavel Ivanov, Tampere (FI)

(21) Appl. No.: 17/130,926

(22) Filed: Dec. 22, 2020

(51) Int. Cl. G01C 5/00

(52) U.S. Cl. CPC G01C 5/00; G01S 19/45

(57) ABSTRACT

A method includes receiving an ambient pressure p1 measured at a time t1 by a mobile communication device at a geographic location g1. The method also includes receiving an ambient pressure p2 measured at time t2 within a ground level geographic location g2 near the geographic location g1. The method also includes receiving an indication of ambient pressure change between the time t1 and the time t2 from at least one geographic location within a maximum distance from the geographic location g1. The method also includes estimating an elevation of the mobile communication device at the time t1 using the indication of ambient pressure change between the time t1 and the time t2 to compensate an ambient pressure difference between the ambient pressure p1 and the ambient pressure p2. The method further outputs the estimated mobile device elevation.

### TECHNICAL FIELD

This disclosure is generally directed to determining a vertical elevation location or altitude of a mobile device. More specifically, this disclosure is directed to a system and method that estimates a vertical elevation, altitude, or a building's floor location of a mobile device's communication relative to, for example, the ground level or ground floor of the building or structure from which the mobile device communicated.

### BACKGROUND

Presently, mobile communication devices (MCDs), such mobile phones and the like, can determine their geographic location using a global navigation satellite system (GNSS), a global positioning system (GPS) or other cellular based geographic positioning systems. When a MCD is inside a covered structure or building, it can sometimes be difficult or impossible for the MCD to utilize global navigation satellite system (GNSS) technology to obtain geographic location services. When indoors, in some structures there exist Wi-Fi based positioning systems (WPS), Bluetooth based positioning systems, and enhanced Wi-Fi infrastructure enable an MCD to determine its geographic location when GNSS signals are unavailable.

In various mobile communication systems, when a user originates an emergency E911 or E112 call on an MCD, an emergency communication system may receive geographic location information from the MCD's communication. The geographic location received by the emergency communication system enables emergency personnel to locate the geographic location of the MCD during the communication with the MCD regardless of whether the call or communication is dropped, disconnected or the user becomes unable to provide, for example, the geographic location or address of the MCD's location where the emergency is occurring.

One drawback of present emergency communication systems is that often an emergency call originates on a building floor above the provided geographic location, for example, on the 7^{th} floor of a building having 15 or more floors. Presently, although some emergency communication systems can obtain or determine the geographic location of an originating MCD communication, obtaining the elevation of or the floor from which the originating MCD communication was made cannot be accomplished. Thus, although obtaining the geographic location of an originating MCD communication is very useful to emergency personnel responding to an emergency call, in an urban environment, for example, where there are multiple floor buildings it would be additionally helpful to emergency personnel if their equipment could receive or determine the elevation or building floor from which the originating MCD emergency call was made.

### SUMMARY

This disclosure relates to a system and method for use to accurately estimate the elevation or altitude of an originating mobile communication device (MCD) using ambient pressure change compensation over a time period.

In a first embodiment, a method includes receiving, by one or more processors, an ambient pressure p1 measured at a time t1 by a mobile communication device at a geographic location g1. The method also includes receiving, by the one or more processors, an ambient pressure p2 measured at time t2 within a ground level geographic location g2 that is near the geographic location g1 (e.g., geographic location g2 is “near” geographic location g1 when geographic location g2 is within about 0 to 500 meters to about 1 km from geographic location g1. In other words, geographic location g2 is near geographic location g1 when geographic location g2 is within a threshold radial distance from geographic location g1 such that the ambient pressure at geographic locations g1 and g2 are for purposes of this disclosure the same for a same ground level elevation and over time). The method also includes receiving, by the one or more processors, an indication of ambient pressure change between the time t1 and the time t2 from at least one geographic location within a maximum distance (e.g., a maximum distance of less than about 10 km) from the geographic location g1 (and/or g2). The method also includes estimating, by the one or more processors, a mobile device elevation e0 of the mobile communication device at the time t1 using the indication of ambient pressure change between the time t1 and the time t2 to compensate an ambient pressure difference between the ambient pressure p1 and the ambient pressure p2; The method also includes outputting, by the one or more processors, the estimated mobile device elevation at the time t1.

In variations of the first embodiment, receiving the ambient pressure p1 occurs during an initial or originating communication from the mobile communication device. In another variation of the first embodiment, the time t2 occurs when a first responder or other personnel responding to the initial emergency communication arrive at ground level of the geographic location g1 or within the ground level geographic location g2 (i.e., within about 1 km of geographic location g1). In another variation of the first embodiment, the ambient pressure p2 is received from a responder mobile device that is being used by the first responder or other personnel responding to the initial emergency communication from the mobile communication device, which originated from the mobile communication device at a geographic location g1, but presently at no elevation e0 above ground level.

In another variation of the first embodiment, the indication of ambient pressure change is received from an entity, wherein the entity may be one of a weather station, an atmospheric pressure reference station, an atmospheric pressure database or at least one other mobile communication device that remains stationary from at least the time t1 to the time t2. In another variation of the first embodiment the indication of ambient pressure change comprises one of an entity ambient pressure p1′ at time t1 and an entity ambient pressure p2′ at time t2, or an entity indication of ambient pressure difference from the time t1 to the time t2.

In additional variations of the first embodiment, the method further includes receiving, by the one or more processors, an indication of elevation difference between a ground level elevation e1 associated with an initial geographic location of a responder mobile device at time t1 and a ground level elevation e2 associated with the geographic location g1 (and/or geographic location g2). The additional variation of the first method also includes receiving, by the one or more processors, an ambient pressure p3 of ground level elevation e1 associated with the initial geographic location of the responder mobile device at the time t1, wherein the indication of ambient pressure change between the time t1 and the time t2 further comprises using the indication of elevation difference to further compensate the ambient pressure difference between the ambient pressure p1 and the ambient pressure p2 due to an elevation change of the responder mobile device between time t1 and time t2.

Additionally, in variations of the first embodiment, the indication of elevation difference is received from at least one of an elevation map database, altitude map database and a system that provides high accuracy altitude data or other devices or entities that provide altitude or elevation data of geographic locations or structures located at geographic locations. In yet another variation, the ambient pressures p2 and p2 are received from the responder mobile device.

In a second embodiment, a system includes at least one memory configured to store instructions and at least one processor coupled to the at least one memory. The at least one processor is further configured when executing the instructions to receive an ambient pressure p1 measured at a time t1 by a mobile communication device at a geographic location g1. The at least one processor is also configured when executing instructions to receive an ambient pressure p2 measured at time t2 within a ground level geographic location g2 near the geographic location g1. The at least one processor is also configured to receive an indication of ambient pressure change between the time t1 and the time t2 from at least one location within a maximum distance (e.g., a maximum distance of less than about 10 km) from the geographic location g1. The at least one processor is also configured to estimate a mobile device elevation of the mobile communication device at the time t1 using the indication of ambient pressure change between time t1 and the time t2 to compensate an ambient pressure difference between the ambient pressure p1 and the ambient pressure p2. Additionally, the at least one processor is configured to output the estimated mobile device elevation at time t1.

In a third embodiment, at least one non-transitory computer readable medium contains instructions that when executed cause at least one processor to receive an ambient pressure p1 measured at a time t1 by a mobile communication device at a geographic location g1, but at an unknown elevation e0 at time t1; receive an ambient pressure p2 at a time t2 within a ground level geographic location g2 near the geographic location g1; receive an indication of ambient pressure change between the time t1 and the time t2 from at least one location within the maximum distance from the geographic location g1; estimate a mobile device elevation of the mobile communication device at the time t1 using the indication of ambient pressure change between time t1 and the time t2 to compensate an ambient pressure difference between the ambient pressure p1 and the ambient pressure p2; and output the estimated mobile device elevation at the time t1.

Other technical features may be readily apparent to one skilled in the art from the following figures, descriptions, and claims.

### BRIEF DESCRIPTION OF THE DRAWINGS

For a more complete understanding, reference is now made to the following description taken in conjunction with the accompanying drawings in which:

FIG. 1 illustrates an example system for use in determining the altitude of an originating mobile communication device (MCD) communication using pressure change compensation over time in accordance with embodiments of this disclosure;

FIG. 2 illustrates an example configuration for computing devices, such as a server, database, desktop computer, workstation or mobile communication devices that may be used in embodiments of the present disclosure;

FIG. 3 illustrates another example configuration for computing devices such as smart phones, desktop computers, laptop computers, or mobile communication devices that may be used in embodiments of the present disclosure;

FIG. 4 illustrates an example environment in which the system or method for determining the altitude of an originating MCD communication using pressure change compensation over time can be performed in accordance with embodiments of this disclosure;

FIG. 5 illustrates an example method for determining the altitude of an originating MCD communication that uses pressure change compensation according to embodiments of this disclosure.

### DETAILED DESCRIPTION

Referring now to the drawings, wherein like reference numbers are used herein to designate like elements throughout, the various views and embodiments of pressure change compensation for elevation positioning, for example elevation positioning of a received call or communication in an emergency E911/E112 system, are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

It is well known that atmospheric pressure decreases as altitude increases. Additionally, it is known that barometric pressure can be used to determine altitude above sea level for a known temperature, humidity, and other ambient weather conditions. Using this knowledge, one way the elevation of an object above ground level can be determined is by measuring the ambient pressure p2 at ground level e2 and the ambient pressure p1 at the altitude location e0 of the object, then subtracting p1 from p2 to determine an ambient pressure difference (ΔP) between the ambient pressures p1 and p2. The ambient pressure difference ΔP can be used to provide the elevation of the object above ground level. Here in this basic example, it is important to understand that the ambient pressures p1 and p2 are measured at the same time.

Equation 1 shows that the ambient pressure difference ΔP is equal to p2−p1.

ΔP=p2−p1 Equation (1)

In a First Example, the ambient pressure difference ΔP can produce reliable values of the difference in height between points at a same geographic location (e.g., a point at ground level and a point nearly directly above the point at ground level) in an area of similar atmosphere. “Area of similar atmosphere” generally means in a same geographic area at and very close to the same time. Taking the ambient pressure measurements p1 and p2 in the same geographic area at or very close to the same time is necessary because ambient pressures at a geographic location change and fluctuate over time. In fact, the ambient pressure a most geographic locations change or fluctuate from 0 to about 10 Pascals per minute (Pa/min) due to changing weather conditions in and around the geographic location. Therefore, for Equation 1 to provide an accurate altitude of an object's elevation position above ground level, the ambient pressures p1 and p2 need to be measured at substantially the same time. So, for this Example 1, assume an object is located on one of 15 floors of a building located at a geographic location. Assume also that each building floor is 3 meters high and that under the present atmospheric conditions the ambient pressure changes 14 Pascals/meter (14 Pa/m) of altitude. If the ambient pressure p1 at the elevated object is measured as 1069 Pa and at substantially the same time the ambient pressure p2 at the ground level of the building is measured as 1300 Pa, then the ΔP=1300 Pa−1069 Pa=231 Pa. Thus, the altitude difference between the ground level and the object is equal to 231 Pa/(14 Pa/m)=16.5 meters. With each building floor being 3 meters high, the object is 16.5 m/(3 m/floor)=5.5 floors above the ground level of the building and can be found on the 5^{th} floor. Again, it is important to note that this altitude or elevation calculation works most accurately when the ambient pressures, p1 and p2, at the object and ground level, respectively, are in the same geographic location area and measured at substantially the same time.

In many real-world circumstances, it is often difficult to measure the two ambient pressures, p1 and p2, at similar enough times to determine an accurate ambient pressure difference ΔP and ultimately the altitude or elevation difference at the geographic location. For example, assume an emergency call from a mobile communication device (MCD) is made from inside a 20-story building. The emergency call may have been made using an emergency response system, such as an E911 or E112 emergency response system (herein after “E911 system”) provided in the United States and Europe. Further, assume the E911 system desires to obtain the geographic location of the MCD originating the E911 call as well as information that can provide or be used to determine the floor of the building where the emergency call originated.

First, with respect to obtaining the geographic location of the originating MCD call, through a variety of presently known techniques (i.e., GNSS, Wi-Fi, cellular tower triangulation, etc.), when a caller originates an emergency E911 call using an MCD, the geographic location information (g1) of the originating MCD at the time of the call (t1) may be either provided by the originating MCD to the E911 system as, for example, GPS or GNSS geographic location coordinate data information or by other geographic location determination techniques. In some circumstances, the user of the MCD may converse, text or video chat with an emergency system operator and provide a location address and other information. Once obtained by the emergency system, the geographic location g1 of the originating MCD at the time of the originating call t1 can stored by the emergency response system and further communicated to emergency personnel via land line and mobile communication devices as the emergency personnel prepare to go to the emergency's geographic location g1.

With respect to obtaining information to help determine the altitude, elevation, or building floor of the originating MCD at the time of the originating call, many present day MCDs, such as mobile phones, smart phones, tablets, and other mobile communication devices, have built in circuitry and sensors enabling an ability to measure the ambient pressure at the MCD's location at a time (t1) during of the originating E911 call. This initial ambient pressure information p1 measured by the originating MCD at time t1 can be provided as data information by the MCD to the emergency response system at the time of and via the originating MCD communication with the emergency E911 system. Assuming, the initial ambient pressure p1 measured at time t1 is stored by the E911 system and further communicated to the emergency personnel going to the geographic location g1 are at least to a geographic location near thereto. For example, the designated geographic location g1 may be inaccessible to the emergency personnel upon arrival. Thus, the emergency personnel will most likely travel to a ground level location (i.e., geographic location g2) near or close to the provided geographic location g1. Upon arrival at geographic location g2 (which in some circumstance may be the same as geographic location g1) at time t2, the emergency personnel can measure the ground level ambient pressures p2 at the arrival time t2.

But wait, there is a now a problem. The problem is that time has elapsed between the initial time t1 of the originating emergency call and the arrival time t2 of the emergency personnel or first responders at a ground level geographic location g2. In real life, for example, in a metropolitan city during rush hour, it can take 15 to 40 minutes or longer for first responders to arrive at an emergency location after an initial emergency E911 system communication is made. As such, the ambient pressures p1 and p2, where not measured at about same time.

As is mentioned above, the ambient pressure at most geographic locations changes and fluctuates over time due to changing weather conditions such as changes in wind speed or direction, temperature, or humidity conditions. The ambient pressure of a geographic location can change or fluctuate, for example, as much as about 5 to 10 Pa/min during normal ongoing weather condition changes.

Referring again to the above discussed First Example but creating a Second Example further assuming, due to weather conditions, the ambient pressure at the geographic location g2 is increasing, decreasing, or fluctuating by about 5 Pa/min. Also, assume 15 minutes elapsed between the time t1 of the originating emergency call and the time t2 the emergency personnel arrive at the street level or ground level location g2 of a multiple floor building wherein the originating MCD communication was made. At the time t2 of the emergency personnel's arrival at the geographic location g2, the ground level ambient pressure p2 can be measured by the emergency personnel using, for example a second MCD device. Since, 15 minutes have elapsed from time t1 of the original MCD communication, the ground level ambient pressure p2 may have changed by as much as +/−75 Pa (i.e., +/−5 Pa/min×15 min) at geographic location g2 since the time t1 of the originating call.

Thus, in this Second Example, the measured ambient pressure p2 at the ground level at geographic location g2 could be as high as 1375 Pa or as low as 1225 Pa. (Remember, as discussed above, at the time t1, p1 was 1069 Pa). Using Equation (1), the AP of p2−p1 could be as high and low as 306 Pa and 156 Pa, respectively. Again, assuming a pressure change of 14 Pa/m, the calculated altitude difference between the ground level at geographic location g2 and the originating MCD can be anywhere from 306 Pa/(14 Pa/m)=21.8 m and 156 Pa/(14 Pa/m)=11.14 m. Here in Example 2, instead of accurately finding the building floor where the originating MCD is located is the fifth floor (i.e., 5.5 floors above the building ground level), the emergency personnel with find that when using an average height of 3 m/floor, the originating MCD could be anywhere between the seventh floor (i.e., 7.2 floors above building ground level) and the third floor (i.e., 3.75 floors above the building ground level) of the building due to ambient pressure changing at geographic location g1 during the 15 minutes between the original MCD emergency communication and the arrival of emergency personnel at the ground level of the geographic location g2.

In this Second Example, it would probably be considered not very useful for emergency personnel or first responders to arrive at an emergency location in a multi-story building and only be able to determine that the emergency may be occurring on any one of the 3^{rd} floor through 7^{th} floor. Presently, first responders do not have a system or technique to accurately determine an elevation or range of floors of the emergency situation location. The first responders may be told by their dispatcher that the emergency situation is on the 4^{th} floor. But, if upon checking the 4^{th} floor, the first responders do not find the emergency situation, they must begin searching for the emergency situation on other floors.

To address the above problem and other issues, the embodiments disclosed herein provide systems and methods for accurately estimating the elevation above ground level or accurately estimating the actual building floor of a multiple floor building of a mobile communication device (MCD) communication. For example, from among various types of mobile communications and circumstances, embodiments disclosed herein provide systems and methods for accurately estimating the elevation above ground level or accurately estimating the actual building floor of a multiple floor building from which an originating MCD communicated with, for example, an emergency E911 system at a time t1. While some of the embodiments are described herein in the context of locating an MCD on one of a plurality of floors of a multiple floor building, it will be understood by one of ordinary skill in the art that the principles described herein can be applied in other scenarios, including without limitation, industrial manufacturing or warehouse buildings, multi-level basements or parking garages (above ground or underground), shopping malls, and mining tunnels, as well as outdoor environments, such as stadiums, skiing slopes, and amusement park rides. Additionally, while some of the embodiments are described in the context of emergency system E911/E112 communications and locating the geographic location of an originating user's mobile communication device, it will also be understood that principles described herein can be applied in other scenarios, including but not limited to non-emergency situations for 3-dimensionally geographically locating lost objects, people, packages, suitcases, internet-of-things (IOT) connected devices or systems, electronic computing devices, determining elevations of distant geographic locations that an electronic computing device, such as a flying drone or other device, is to land, or to aid in navigating autonomous devices in and around structures.

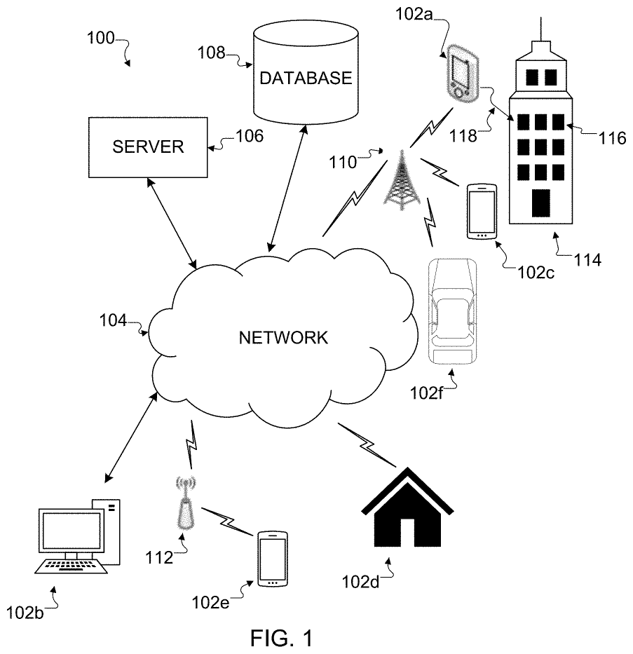

Referring now to FIG. 1, which illustrates a system 100 that may determine the altitude of a mobile communication device (MCD) communication using pressure change compensation over time in accordance with embodiments of this disclosure. As shown in FIG. 1, the system 100 can include multiple computing devices 102a-102f, at least one network 104, at least one server 106, at least one database 108, a base station 110, and a wireless access point 112. Note, however, that other combinations and arrangements of components may also be used here.

In this example, each computing device 102a-102f is coupled to or communicates over the network 104. Communications between or involving each computing device 102a-102f and the network 104 may occur in any suitable manner, such as via a wired or wireless connection. In this example, some of the computing devices (102a, 102c, 102f) communicate via one or more base stations 110, such as cellular base stations or eNodeBs (eNBs). Further, in this example, computing device 102e communicates with the network 104 via one or more wireless access points 112, such as IEEE 802.11 wireless access points. Note that these are for illustration only and that each of the computing devices 102a-102f could communicate directly to the network 104 or indirectly with the network 104 via any suitable intermediate device(s) or network(s).

Each computing device 102a-102f represents any suitable device or system capable of providing information to the server 106 or database 108 or to receive information from the server 106 or database 108. Example types of information may include, voice communications, device identification information, geographic location information, ambient pressure information, route information, geographic location elevation information, estimated time of arrival information, emergency communication system information, and the like. Any suitable number(s) and type(s) of computing devices 102a-102f may be used in the system 100. In this particular example, the computing device 102a represents a first smart phone computer that may also be referred to herein as the first or originating mobile communication device (MCD), the computing device 102b represents a desktop computer or workstation, the computing device 102c represents a second smart phone computer or MCD that may be specialized equipment or a mobile communication device for use by emergency personnel, the computing device 102d represents a sensing device (e.g., an atmospheric or ambient pressure sensor) that may or may not be incorporated into a weather station or other structure were ambient pressure measurements are performed, the computing device 102e represents a third smart phone computer that may also be referred to herein as a mobile communication device (MCD), and the computing device 102f represents a computer or mobile communication device that is onboard or integrated with a vehicle (e.g., an automobile or rescue equipment vehicle, truck, self-driving vehicle, and like). However, any other or additional types of computing devices may be used in the system 100, such as a smart video display screen, a communication tower computer, a weather station computer, a portable tablet style computer, other types of sensors and the like. Each computing device 102a-102f includes any suitable structure configured to transmit and/or receive information.

The network 104 facilitates communication between various components of the system 100. For example, the network 104 may communicate Internet Protocol (IP) packets, frame relay frames, Asynchronous Transfer Mode (ATM) cells, or other suitable information between addresses. The network 104 may include one or more local area networks (LANS), metropolitan area networks (MANS), wide area networks (WANS), all or a portion of a global network such as the internet, or any other communication system or system at one or more locations. The network 104 may also operate according to any appropriate communication protocol or protocols.

The server 106 is coupled to the network 104 and is coupled or otherwise communicates with the database 108. The server 106 supports the retrieval of information from the database 108 and the processing of that information. Of course, the database 108 may also be used within the server 106 to store information, in which case the server 106 may store the information itself. Among other things, the server 106 may process information to determine the altitude of an originating mobile communication device (MCD) communication using pressure change compensation over time in accordance with embodiments of this disclosure. The server 106 includes any suitable structure configured to process information necessary to determine the altitude or elevation (above or below ground level) of an MCD, such as first MCD 102a, after either the MCD or an embodiment of the system 100 originates a communication with one or the other. In some embodiments, the server 106 includes one or more processors, one or more memories, and one or more communication interfaces. Note, however, that the server 106 may be implemented in any suitable manner to perform the functions described herein. Also, note that while described as a server here, the electronic computing device(s) actually implementing the server 106 may represent one or more desktop computers, laptop computers, server computers, one or more mobile communication devices, computing device(s), or other computer or data processing devices or systems.

The database 108 stores various and provides information used, generated, or collected by the server 106 and one or more of the computing devices 102a-102f. For example, the database 108 may store, time stamped information, ambient pressure information, MCD identification information, user identification information, geographical location information, geographical map information, routing information, building structure and geographic location information, geographic elevation map information, weather records information, MCD location information, weather station location information, and the like. The database 108 may support any suitable technique for storing and retrieving information.

FIG. 1 also illustrates a building 114 having multiple floors. In the disclosed examples, the first MCD 102a is indicated as being located on a 5^{th} floor 116 of building 114 via arrow 118. It is understood that the location of MCD 102a could be on any floor of building 114 or in or on any structure and at an altitude or elevation ranging from ground level to the top of the building 114 or substantially any structure. As such, the location of MCD 102a shown in FIG. 1 is shown as an example location and does not limit this disclosure to locating the altitude or elevation of any originating MCD communication to any particular type of structure, object, location, or 3-dimensional geographic location.

In various embodiments there are several ways to implement the system 100 or portions of the system 100 in order to provide the described functionality that determines and provides the altitude or elevation above ground level of an originating MCD communication with one or more devices in the system 100. For example, in some embodiments, the server 106 and data base are owned, operated, or managed by a common entity. In other embodiments, the server 106 and database 108 are owned, operated, or managed by more than one entity. In yet other embodiments, a desktop computer, laptop, or workstation, such as desktop computer 102b and a mobile communication device MCD, such as 102c may be owned by the same or different entities, yet are running or operating software, programs, and/or applications that are owned, operated, managed, or controlled by the same entity, or in some circumstances, different entities.

Although FIG. 1 illustrates one example of a system 100 for use in accurately estimating an altitude or elevation of an MCD that originated an MCD communication, various changes can be made to FIG. 1. For example, the system 100 could include any number of each component in any suitable arrangement. For example, any number of electronic computing devices 102a-102f, networks 104, servers 106, and databases 108 could be used. In some embodiments, only a single computing device such as workstation 102b or MCD 102c may be required to communicate with another MCD, such as the first MCD 102a that originates communication with system 100. In yet other embodiments, the system 100 originates a communication with an electronic computing device 102a, to initialize estimating an elevation of the electronic computing device 102a. Also, while FIG. 1 illustrates that one database 108 is coupled to the network 104, any number of databases 108 may reside at any location or locations and be accessible by the server or one or more other devices in the system 100. Furthermore, each database 108 may be coupled directly or indirectly to the server(s) 106. In general, computing and communication systems come in a wide variety of configurations, and FIG. 1 illustrates one operational environment in which various features disclosed in this disclosure can be used, yet the various features disclosed herein could be used or incorporated into any other suitable system.

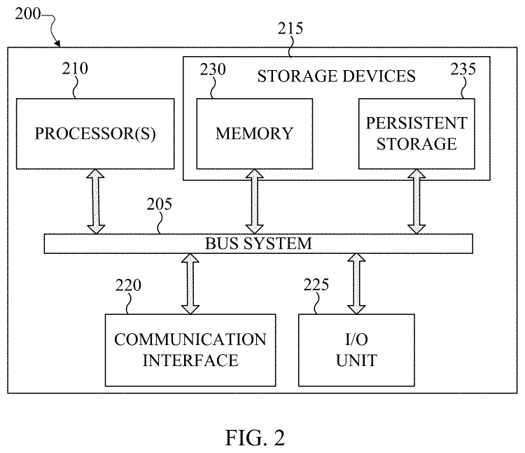

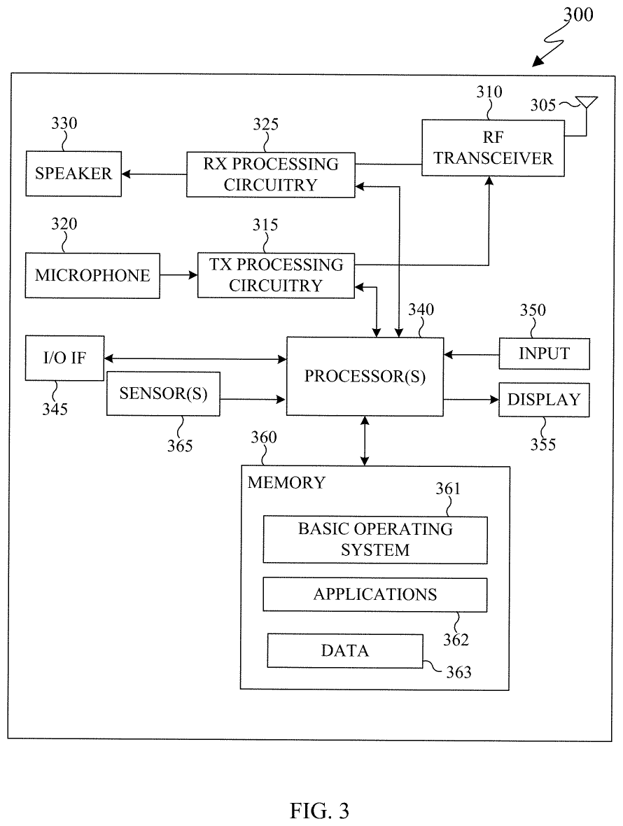

FIG. 2 and FIG. 3 illustrate example configurations for computing devices in the system 100 in accordance with embodiments of the present disclosure. FIG. 2 illustrates an example configuration for a computing device 200, such as for the server 106. FIG. 3 illustrates an example configuration for a computing device 300, such as for smart phone computers, electronic computing devices or MCDs 102a, 102c and 102e.

Referring to FIG. 2, the computing device 200, which may be server 106 can represent one or more servers. As shown in FIG. 2, the server 106 includes a bus system 205 that supports communication between at least one processor(s) 210, at least one storage device(s) 215, at least one communications interface 220, and at least one input/output (I/O) unit 225.

The processor executes instructions that can be stored in memory 230. The processor 210 can include any suitable number(s) and type(s) of processors or other devices in any suitable arrangement. Examples types of processor(s) 210 include microprocessors, microcontrollers, digital signal processors, field programmable gate arrays, application specific integrated circuits, and discrete circuitry.

Memory 230 and persistent memory 235 are examples of storage devices 215 that represent a structure(s) capable of storing and facilitating retrieval of information (such as data, program code or other suitable information on a temporary or permanent basis). The memory 230 can represent random access memory or any other suitable volatile or non-volatile storage device(s). The persistent memory 235 can contain one or more components or devices supporting longer-term storage of data, such as read only memory, hard drive memory, flash drive memory or optical disk memory. Memory 230 thus, includes a non-transitory processor or computer readable medium that contains instructions that can be executed by the processor(s) 210.

The communications interface 220 supports communications with other systems or devices. For example, the communications interface 220 could include an interface card or a wireless transceiver facilitating communications of the network 104. The communications interface 220 can support communication through any suitable physical or wireless communication link(s).

The I/O unit 225 allows for input and output of data and information. For example, the I/O unit 225 can provide a connection for user input through a keyboard, mouse, keypad, touchscreen, or other suitable input device. The I/O unit 225 can also send output to a display, printer, or other suitable output device.

Note that while FIG. 2 is described as representing the server 106 of FIG. 1, the same or a similar structure could be used in one or more of the various computing devices 102a-102f For example, a desktop computer workstation 102b or the second MCD 102c may be specialized mobile communication equipment for use by emergency personnel (or other specified personnel) and could also have the same or a similar structure shown in FIG. 2.

FIG. 3 illustrates a computing device 300 that could be one or more of the computing devices shown in FIG. 1 in accordance with an embodiment of this disclosure. The embodiment of the computing device 300 in FIG. 3 is for illustration only and other embodiments could be used without departing from the scope of this disclosure. The computing device 300 can come in a wide variety of configurations, and FIG. 3 does not limit the scope of this disclosure to a particular implementation of a computing device. In certain embodiments, one or more of the computing devices 102a, 102c, and 102e of FIG. 1 can include the same or similar configuration as computing device 300. In fact, in various embodiments computing devices 102b-102f may be interchangeable.

In certain embodiments, the computing device 300 is useable in environment sensing, communication, data retrieval, navigation, geographic location determination, and altitude calculations. For example, the computing device 300 can measure or receive ambient pressure information, determine its geographic location, and execute a plurality of program applications including an application for determining the altitude of another computing device. The computing device 300 can be a mobile communications device (MCD), such as, for example, a wireless terminal, a desktop computer (e.g., the desktop computer 102b of FIG. 1), a smart phone or personal digital assistant/tablet (e.g., the computing devices 102a, 102c, 102e or 102f of FIG. 1), and reasonable derivations thereof.

As shown in FIG. 3, the electronic computing device 300 includes an antenna 305, a communication unit 310, transmit (TX) processing circuitry 315, a microphone 320, and receive (RX) processing circuitry325. The communication unit 310 can include, for example an RF transceiver, a BLUETOOTH transceiver, a WI-FI transceiver, a ZIGBEE transceiver and other types of transceivers. The electronic computing device 300 also includes a speaker 330, a processor 340, an input/output (I/O) interface 345, an input 350, a display 355, a memory 360, and one or more sensors 365. The memory 360 includes the operating system (OS) 361, applications 362 and user data 363. As such, memory 360, includes a non-transitory processor or computer readable medium containing instructions that can be executed by the processor(s) 340.

The communication unit or RF receiver 310 receives, from the antenna(s) 305, an incoming RF signal transmitted from an access point (such as BLUETOOTH or a Wi-Fi signal from access point 112) or from a base station 110 (such as Wi-Fi, BLUETOOTH, cellular, 5G, LTE, LTE-A, WiMax, or any other type of wireless network). Additionally, the incoming RF signal may be provided directly from the network 104 via any type of wireless network. The communication unit 310 can down-convert the incoming RF signal to generate an intermediate frequency or baseband signal. The intermediate frequency or baseband signal is provided to the RX processing circuitry 325 that generates a processed baseband signal by filtering, decoding and/or digitizing the baseband or immediate frequency signal, or a combination thereof. The RX processing circuitry 325 can provide the processed baseband signal to the speaker 330 (such as for voice data) or to the processor 340 for further processing (such as for web browsing data, application related data, or operational related data).

The TX processing circuitry 315 receives analog or digital voice data from the microphone 320 or other outgoing base band data from the processor 340. The outgoing baseband data can include web data, e-mail, interactive data, or application related data. The TX processing circuitry 315 encodes, multiplexes, digitizes, or a combination thereof, the outgoing baseband data to generate a processed baseband or intermediate frequency signal. The communication unit 310 receives the outgoing processed baseband or intermediate frequency signal from the TX processing circuitry 315 and up-converts the baseband or intermediate frequency signal to an RF signal for transmission via the antenna(s) 305.

The processor 340 can include one or more processors or other processing devices and execute the OS 361 stored in the memory 360 in order to control the overall operation of the electronic computing device 300. For example, the processor 340 could control the reception of forward channel signal and the transmission of reverse channel signals by the communication unit 310, the RX processing circuitry 325, and the TX processing circuitry 315 in accordance with well-known principles. The processor 340 is also capable of executing applications or other software 362 resident in the memory 360, such as one or more stored applications for data sharing, data calculation and/or manipulation, interactive applications, background running services, sensor(s) 365 operation, the OS 361 or external computing devices or sensors applications, encryption, and the like.

The processor 340 can execute instructions that are stored in the memory 360. The processor 340 can include any suitable number(s) and types or processors or other devices in any suitable arrangement. For example, in some embodiments, the processor 340 includes at least one microprocessor or microcontroller. Example types or processor 340 include microprocessor, microcontrollers, ARM processors, multiple core processors, parallel processor, digital signal processors, field programmable gate array processors, application specific integrated circuits, and discrete circuitry.

The processor 340 is also capable of executing other processes resident in the memory 360, such operations may receive, store, modify, process or display image data, for example on the display 355. The processor 340 can move data into or out of the memory 360 as required by an executing process. In some embodiments, the processor 340 is configured to execute a plurality of applications 362 based on the OS 361 or in response to signals received from external devices, such as eNBs, sensors, computing devices, internet-of-things (IOT) devices and the like. The processor 340 is also coupled to the I/O interface 345 that provides the electronic computing device 300 with the ability to connect to other devices, such as other computing devices (i.e., computing devices 102a-102f). The I/O interface 345 the one of the communication paths between these external accessories and the processor.

The processor 340 is also coupled to the input 350 and the display 355. The operator or user of the electronic computing device 300 can use the input 350 to enter data or inputs into the electronic computing device 300. Input 350 can be a keyboard, touch screen, mouse, track ball, voice input, or other device capable of acting as a user interface to allow a user to interact with the electronic computing device 300. For example, the input 350 can include voice recognition processing thereby allowing a user to input a voice command via the microphone 320. In another example, the input 350 can include a touch panel, a (digital) pen sensor, a key, or an ultrasonic input device. The touch panel can recognize, for example, a touch input in at least one scheme among a capacitive scheme, a pressure sensitive scheme, an infrared scheme, or an ultrasonic scheme. The input 350 can also include a control circuit. In the capacitive scheme, the input 350 can recognize touch or proximity with the aid of the control circuit. The display 355 can be a liquid crystal display (LCD), a light emitting diode (LED) display, optical LED (OLED) display, an active-matrix OLED (AMOLED) display or other display capable of rendering text and/or graphics in accordance with an intended use or function of the electronic computing device 300.

Input 350 can be associated with sensor(s) 365 by providing additional input to the processor 340. For example, if one of the sensor(s) 365 is a camera, the camera can capture images, such as objects, QR codes, bar codes, symbols, or other indicia to be processed by the electronic computing device in accordance with an application's instructions or the captured images can be passed onto the server 106 or other electronic computing device in communication with the network 104.

In certain embodiments, sensor(s) 365 can include one or more sensors that can meter a physical quantity or detect an activation state of the electronic computing device 300 and further convert the metered or detected information in an electrical signal such as direction, distance, speed, acceleration over time, or changes over time. In certain embodiments, sensor(s) 365 can include inertial sensors (such as accelerometers, gyroscopes, and magnetometers), optical sensors, pressure sensors, ambient pressure sensors, barometric pressure sensors, altimeters, motion sensors, geographic positioning system (GPS) related sensors, cameras, heart rate sensors, breath analyzer sensors or breath sensors (such as a microphone), and the like. For example, sensor 365 can include one or more buttons for touch input (such as a button on a connected headset or on the electronic computing device 300), a camera, a gesture sensor, a gyroscope or gyro sensor, an air pressure sensor, a magnetic sensor or magnetometer, an acceleration sensor or accelerometer, a grip sensor, a color sensor, a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an iris sensor, a fingerprint sensor, and the like. Any one or more of the sensor(s) 365 can further include a control circuit for controlling one or more of the associated sensor(s) included therein. The sensor(s) can be used to determine an orientation and facing direction, as well as the geographic location of the electronic computing device 300. Any of the sensor(s) 365 can be located on or within the electronic computing device 300 or be another electronic computing device in direct, indirect, connected, or wireless communication with electronic computing device 300.

The memory 360 is coupled to the processor 340. Part of the memory 360 could include random access memory (RAM), and another part of the memory 360 could include a Flash or other type of read-only memory (ROM).

The memory 360 can include persistent storage (not shown) that represents any structure(s) capable of storing and facilitating retrieval of information (such as data, program code, application code or instructions, and/or suitable information on a temporary or permanent basis). The memory 360 can contain one or more components or devices supporting longer-term storage of date such as read-only memory, hard drive(s), Flash memory, or optical memory. The memory 360 can contain user data that may include profile data and user history data. User data may also contain data received from one or more sensor(s) 365. User data can be biographical data and/or diametric data.

Although FIGS. 2 and 3 illustrate examples of devices in a computing system, various changes can be made to FIG. 2 or 3. For example, various components in FIGS. 2 and 3 could be combined, further subdivided, or omitted and additional components could be added according to particular needs. As a particular example, the processor 340 could be divided into multiple processors, such as one or more central processing units (CPUs) and one or more graphics processing units (GPUs), and one or more communication processing units (COMPUs). In addition, as with computing and communication networks, electronic computing devices and servers can come in a wide variety of configurations, and FIGS. 2 and 3 do not limit this disclosure to any particular electronic computing device or server.

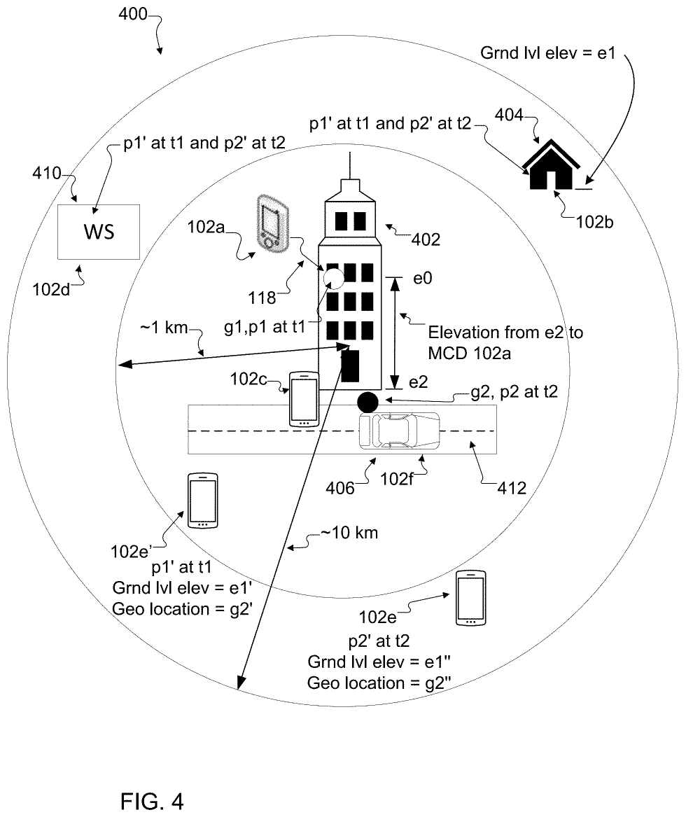

Referring now to FIG. 4, an example of a system and method that determines and provides the altitude or estimated building floor number on which an MCD, such as first MCD 102a, originated a communication with system 100 in accordance with this disclosure is now discussed. In some embodiments, the system 100 may originate communication with and electronic computing device, such as first MCD 102a, and the electronic computing device's initial communication to the system 100 is in response thereto. FIG. 4 illustrates a geographic map 400 depicting geographic locations of various devices that may be in or utilized by system 100. The various devices are shown in locations relative to a building 402 where, in this example, an originating MCD 102a is located at a geographic location g1 inside and multiple floors above the ground level of building 402. Although geographic location g1 is shown in FIG. 4 to have an elevation above the ground level of building 402, it should be understood that the geographic location g1 is a 2-dimensional map or ground level location of where the originating MCD 102a is located in building 402 without any elevation information associated with it. Thus, herein a geographic location is a map location that is associated with x-y coordinates, or latitude and longitude location designation. A geographic location, such as geographic location g1 does not include altitude or elevation information for the designated location. Additionally, in this example, the originating or first MCD 102a is located on one of the floors of building 402 at an elevation (e0) or altitude above the ground or street level 412 of building 402. Although in this example building 402 is referred to as a building, it is understood that the building 402 can be any type of natural or manmade structure, location, or object from which the originating or first MCD 102 can communicate to and from the network 104. A non-limiting list of natural or manmade structure examples include, an apartment building, office building, home, hotel, airport, rock formation, treetop, tower, monument, parking deck, stadium, amusement park, ski resort, balloon, theater, cruise liner ship, and the like.

In this example of system 100 an emergency E911/E112 (hereinafter E911) system that receives emergency communications is discussed, but it is understood that this example does not limit the scope of this disclosure to emergency E911 system communications. Here a user with a first MCD 102a smart phone is in building 402 on the 5^{th} floor at geographic location g1. In this example, an emergency occurs, and as a result the user originates an E911 call to an emergency service on the first MCD 102a smart phone. The E911 call to the emergency service may be referred to herein as an originating MCD communication. The E911 call or originating MCD communication may be received at an emergency service location workstation 102b via the network 104. The workstation 102b in this example can be the workstation of an emergency call operator who works for the emergency service at the emergency service location 404. The workstation 102b can receive the originating MCD communication from the first MCD 102a. The originating MCD communication can include data or information that provide a geographic location g1 and an ambient pressure p1 measured by the originating MCD 102a at a time t1 of the communication (i.e., the originating MCD communication can include g1 and p1 at time t1). In some embodiments, the MCD user may be able to talk to the emergency call operator during the originating communication and provide their address or the name of the building. But, in other circumstances the user may not be able to provide the floor or apartment number in the building which he is located. Thus, in various embodiments, when the user initiates an E911 communication, and regardless of whether the user communicates verbally during the originating communication with the emergency service, the emergency system 100 can requests and the initiating MCD 102a provides, for example, the E911 workstation 102b the geographic location g1 and a measured ambient pressure p1 of the MCD 102a that was measured at a t1 during the initial communication. The received geographic location g1 and ambient pressure p1 of the MCD 102a at time t1 can be stored to the memory of the workstation 102b, the server 106, the database 108 or other computing device 102a-102f. Note that the network 104, server 106 and database 108 are not specifically shown in FIG. 4 because their geographic locations can be substantially anywhere and not critical to this discussion. Additionally, in some embodiments, the ambient pressure p1 is provided time t1 during the initial communication with the emergency E911 service as part of an application running in the first MCD 102a and associated with the system 100. In other embodiments, when a communication is made between the system 100 and the first MCD 102a, electronic computing device in the system 100 can request via a digital request embedded in the initial communication or via an associated communication with the first MCD 102a for the first MCD 102a to measure the ambient pressure p1 and provide it along with the time t1 the measurement to the system 100.

After the originating MCD communication from MCD 102a is received by the E911 emergency system 100 and the geographic location g1 and ambient pressure p1 at t1 are stored, emergency personnel may be contacted by system 100. The geographic location g1 and ambient pressure p1 at time t1 can be provided to a second computing device or second MCD 102c used by the emergency personnel or first responders. In some embodiments, the second MCD 102c may be in or incorporated as part of a transportation vehicle 406 (i.e., MCD 102f in FIG. 1) used by the first responders to travel to an emergency location from an initial geographic location 404. The initial geographic location 404 may be an emergency service station such as a fire station, hospital, police station or the like. In various embodiments, the second MCD 102c may be a smart phone computer that is part of specialized equipment or be a mobile communication device for use by emergency personnel. The second MCD 102c can include software or an application(s) stored in its memory in accordance with this disclosure. For example, such applications may include an application for accurately estimating the elevation of building floor of a building based on elevation positioning techniques and embodiments disclosed herein. In some embodiments, the software or application(s) in the second MCD 102c (or the MCD 102f in vehicle 406) may include instructions for the second MCD 102c or MCD 102f to request and receive the geographic location g1 and ambient pressure p1 information via the network 104 from the workstation 102b, the server 106, the database 108 or other MCD or computing device 102a-102f. In some embodiments, the second MCD 102c or MCD 102f may receive the geographic location and ambient pressure directly from the originating MCD communication of the first MCD 102a. In other configurations the necessary geographic location, time and ambient pressure information may be pushed to the second MCD 102c from to one or more other electronic computing devices in the system 100. In yet other embodiment configurations, the second MCD 102a may request the necessary geographic location, time, and ambient pressure information from one or more other electronic computing devices in the system 100 or from one or more entities outside of system 100 that can provide pressure/time measurement data for various geographic locations.

Additionally, in various embodiments, the second MCD 102c can use the provided g1 information to map a route from the emergency service location 404 or an initial geographic location of the second MCD 102c. When the geographic location g1 of the originating call is determined to be within a structure, such as building 402, a navigation application or other software stored in the second MCD 102c may determine a geographic location g2 on a map that is very close to or proximate to the building 402 where the first responders can arrive such as a location on a street 412 proximate to or near building 402. Herein a location, such as a geographic location g1 is “near” geographic location g2 when, for example, geographic location g2 is within about 0 to about 1 km from geographic location g1. In other words, geographic location g1 is “near” geographic location g2 when geographic location g2 is within a threshold radial distance from geographic location g1 such that the ambient pressure at geographic locations g1 and g2 are for purposes of this disclosure the same for a same ground level elevation over time). In some embodiments, the geographic location g2 is considered near to the geographic location g1 when geographic location g2 is at street or ground level just outside the building 402. In other embodiments, geographic location g2 may be on a designated floor of the structure or building 402 above or below ground level and the elevation calculations can be compensated accordingly. Additionally, the elevations of building floors above (or below) ground level may be retrievable from the database 108 by the system 100 or entered into the system 100 by a first responder using, for example, the second MCD 102c's input(s) 350.

Ground level for purposes of geographic locations g1 and g2 is defined herein as the ground level, lobby level or street level of the structure or building 402.

At a time t2 an ambient pressure p2 is measured by the second MCD 102c (i.e., or for example the MCD 102f in vehicle 406). The measurement of the ambient pressure p2 may be performed when the first responders arrive at geographic location g2. The geographic location g2 can be any useful location near of geographic location g1. Geographic location g2 can be next to the building on the sidewalk or in the street 412, it can be on an opposite side of the building 402 where access to first responders is given, but most importantly the ground level e2 ambient pressure measurement taken at geographic location g2 designates the location from which the elevation distance between e2 and the first MCD 102a elevation e0 is measured.

In various embodiments, the measurement of ambient pressure p2 may be initiated by a software or an application 362 running in the second MCD 102c, via an input initiated by a first responder or user of the second MCD 102c, via a wireless communication from another computing device 102a-102f, or by a communication from the server 106. The second MCD 102c may communicate the time t2, the geographic location g2 and the ambient pressure p2 via the network to the workstation 102b, the server 106, the server 108 or any other computing device 102b-102f in system 100 for storage or other use in accurately estimating the elevation of the first MCD 102a.

Additionally, in various embodiments, the ground level geographic location g2 is considered near geographic location g1 when geographic location g2 is less than about one kilometer (1 km) from the geographic location g1. This in necessary because generally, the ambient pressure within a 1 km radius of a geographic location, such as geographic location g1, will be approximately the same at a same ground level elevation at a given time.

In order to compensate for a change in ambient pressure occurring between time t1 of the initial MCD 102a communication and time t2, when the ambient pressure p2 was measured at the ground level geographic location g2, an indication of the ambient pressure change may be requested and received by the system 100. The indication of ambient pressure change may be determined by using near-real-time pressure information acquired by, stored by, and be retrievable from a weather station, or other ambient pressure measuring location that is nearby the geographic locations g1 and g2. Herein a location of, for example, a weather station, is “nearby” geographic locations g1 and/or g2 when the weather station is within about 0 to 10 km from geographic location g1 and/or g2. In other words, a weather station is “nearby” geographic location g1 and/or g2 when the weather station is within a threshold radial distance from geographic location g1 and/or g2 such that the ambient pressure at geographic locations g1 and g2 are for purposes of this disclosure change a same amount over time. In other words, the nearby ambient pressure measuring location is within a maximum threshold distance wherein that the ambient pressure at geographic location(s) g1 and/or g2 change a same amount as the ambient pressure at the nearby ambient pressure measuring location over time.

The indication of ambient pressure change, in some embodiments is the difference in the ambient pressures measured at times t1 and t2 by a nearby ambient pressure measuring station or weather station 410 or other ambient pressure measuring device that remained stationary between time t1 and time t2.

In some embodiments, ambient pressure measurements p1′ and p2′, an indication of ambient pressure difference information, and/or an indication of elevation difference information may originate from or be provided by a third-party entity's database, weather station, ambient pressure measuring device or electronic computing device. As such, the various systems, methods, and software embodiments of this disclosure are configured to receive third party entity ambient pressure p1′, entity ambient pressure p2′, entity indication of ambient pressure difference information and/or entity indication of elevation difference from the time t1 to the time t2 information from one or more third parties. Non-inclusive examples of third-party entities that embodiment methods, systems, and software in accordance with this disclosure may be configured to receive information from may include government, public or private owned weather stations, ambient pressure measuring locations, mobile communication phones, any other mobile electronic computing devices, and data bases.

The indication of ambient pressure change may be acquired by one or more computing device(s) of the system 100 by requesting and receiving the near-real-time ambient pressure information measured at the pressure measuring station 410 at times t1 and t2 via its associated computing device 102d, wherein the associated computing device 102d measures and stores ambient pressure measurements at discrete intervals or continuously on an ongoing basis over time. The indication of ambient pressure change (i.e., the ambient pressure change over time) may be provided by the computing device 102d, for example, as two ambient pressure measurements taken at times t1 and t2 respectively, or as a positive or negative ambient pressure change from time t1 to time t2. Various embodiments the ambient pressures measured at a plurality of times and locations are stored in and retrievable from the database 108.

The indication of ambient pressure change from time t1 to time t2 may then be used, for example, by the second MCD 102c to compensate for the change, from time t1 to t2, of ambient pressure p2 at the geographic location g2. The indication of ambient pressure change (p₂′−p₁′) is determined by subtracting the ambient pressure measured at time t2 (p₂′) from the ambient pressure measured at time t1 (p₁′) at the pressure measuring station 410. The indication of ambient pressure change is then subtracted from the ambient pressure measurement p2 taken at geographic location g2 at time t2 to compensate the ambient pressure p2 for the total ambient pressure change from time t1 to time t2. The compensated ambient pressure of ambient pressure p2 is shown as p2_{c} in Equation (2).

p2_{c}=[p₂−(p₂′−p₁′)] Equation (2)

In Equation (2), p2_{c} is the compensated ambient pressure p2; And p₁′ and p₂′ are ambient pressures measured at time t1 and t2, respectively, at the ambient pressure measuring station 410

The compensated ambient pressure change p2_{c} is used in place of p2 in Equation (1) to accurately estimate the first MCD 102a's elevation at time t1. Using the indication of ambient pressure change between time t1 and time t2 to compensate for an ambient pressure difference between the ambient pressure p1 and the ambient pressure p2 as shown in Equation (3).

Δp_{c}=p2_{c}−p1=[p2−(p₂′−p₁′)]−p1 Equation (3)

In Equation (3) Δp_{c} is the compensated ambient pressure difference between the ambient pressure p2 at geographic location g2 compensated for the time-domain change from time t1 to time t2; p1 is the ambient pressure measured by first MCD 102a during the originating MCD communication at time t1; p2_{c} is the compensated ambient pressure p2, and p₁′ and p₂′ are ambient pressures measured at time t1 and t2, respectively, at the ambient pressure measuring station 410

The compensated ambient pressure difference Δp_{c} can be used to accurately estimate the originating or first MCD 102a's elevation at the time t1 when the user of the first MCD 102a made the originating emergency call to the E911 system. The accurate estimation of the first MCD 102a's elevation can be performed by software or applications running in the same or different electronic computing devices (i.e., MCD devices of the first responder, nearby weather station, E911 system equipment, etc.) Compensation of the ambient pressure p2 is accomplished by subtracting a determined change in ambient pressure between time t1 and t2 measured at a nearby ambient pressure measuring location 410 from the ambient pressure measurement p2.

The compensated ambient pressure difference Δp_{c} can be used to accurately estimate the elevation from the ground level e2 of geographic location g1 or g2 to the original elevation e0 of the first MCD 102a at time t1 by multiplying the Δp_{c} by an appropriate pressure to elevation conversion factor (see FIG. 4 for ground level e2 and the original MCD 102a elevation e0). For example, as discussed above, under certain atmospheric conditions of pressure, temperature and humidity, ambient pressure may change by 14 Pascals/meter (14 Pa/m) of elevation.

Thus, referring to the First and Second Examples discussed above, here in a Third Example, embodiments of the present disclosure are provided. Here in the Third Example, it is understood that due to weather conditions, the ambient pressure surrounding the geographic location g1 and fluctuate, increase, or decrease up to +/−10 Pa/min. In this example, 15 minutes elapsed from the time t1 of the originating MCD 102a communication and the time t2 when the first responders arrive at geographic location g2. At the time t1 of the originating MCD 102a communication, the first MCD 102a measured the ambient pressure p1 at geographical location g1 to be 1069 Pa. Also, at time t1 the system 100 received from the first MCD 102a, the MCD 102a's geographic location g1, a measured ambient pressure p1 of 1069 Pa and the time t1.

Upon arrival at a ground level geographic location g2, near to g1, 15 minutes later at time t2, the first responders use their second MCD 102c to measure the ambient pressure p2 at ground level. Assume in this example, the measured ambient pressure p2 is 1325 Pa at g2 at time t2. The second MCD 102c may also use the times t1 and t2 to request and receive an indication of ambient pressure change between time t1 and time t2 via the network 104 from, for example, any one of the database 108, the server 106, or other electronic computing devices such as electronic computing devices 102b, 102d, or 102e. Assuming the second MCD 102c receives an indication of ambient pressure change (p₂′−p₁′) equal to 60 Pa, wherein, for example at the nearby weather station 410 the ambient pressures measured and stored at times t2 and t1 are p₂′=1120 Pa and p₁′=1060 Pa, respectively.

Therefore, (p₂′−p₁′)=(1120 Pa−1060 Pa)=60 Pa

Then using, for example, Equation (3) to determine the compensated ambient pressure difference Δp_{c}=[p2−(p₂′−p₁′)]−p1

$$\begin{matrix}= [ p 2 - 60 Pa ] - p 1 \\ = [ 1325 Pa - 60 Pa ] - 1069 Pa \\ = 196 Pa\end{matrix}$$

To accurately estimate the elevation of the first MCD 102a the originating MCD emergency communication was made the compensated ambient pressure difference Δp_{c} (in this example 196 Pa) is divided by 14 Pa/m which equals 14 meters (196 Pa/14 Pa/m=14 m) above ground level. At about 3 m/floor, the 14 meters above ground level accurately estimates the elevation of the originating first MCD 102a at time t1 to have been on the 4^{th} floor of building 402 (i.e., 4.66 floors above the ground level at geographic location g1). In various embodiments the pressure compensation calculations may be performed by the second MCD 102c or any other computing device in the system and may be implemented in various other suitable manners to provide an output of the estimated first MCD 102a elevation at time t1 of the originating call.

Having accurately estimated the elevation or building floor of the originating emergency MCD communication, first responders can more easily locate the emergency on the floor where the emergency call originated.

In another embodiment of this disclosure, determining the indication of ambient pressure change at the ground level of geographic location g1 (and/or g2) between times t1 and t2 may be accomplished by any electronic computing device in the system 100 being configured to receive ambient pressure readings from one or more ambient pressure measuring device(s), provided that each one of the one or more pressure measuring computing devices remains stationary between the times t1 and t2, is geographically located nearby of the geographic location g1 (and/or g2). Thus, an electronic computing device in system 100 may be configured to receive ambient pressure information at times t1 and t2 from any electronic computing device, such as one or more MCD 102e smart phone(s), that is within 10 km of the geographic location g1 (and/or g2), can measure ambient pressure, and remained stationary between the times t1 and t2 to provide ambient pressures measured at times t1 and t2. The MCD 102e smart phones may run an application or software that enables them to be contacted so that pressure, time, and geographic location information can be sent to and received by system 100.

In other embodiments, crowd sourced ambient pressure measurements along with the times and the geographic location where the ambient pressure measurements were taken may be received from hundreds or thousands of MCD 102e smart phone devices and stored in the database 108. For example, the crowd sourced MCD 102a smart phone devices may opt into running an application while the smart phone device is stationary and being charged. The application may run in the background and instruct the MCD 102e to take ambient pressure measurements periodically (e.g., every 5 to 15 seconds) and send the pressure measurement data along with the times and geographic location associated with the measurement for receipt and storage by a database 108 associated with system 100.

In other embodiments of this disclosure, the indication of ambient pressure change from time t1 to time t2 can be determined in various other ways that ultimately compensate for the ambient pressure changes at geographic location g2 (an/or g1) between time t1 of the originating call and time t2 of the arrival of personnel or other devices or equipment at geographic location g2. As such, the Third Example discussed herein does not limit the scope of embodiments of this disclosure to any method, system, or instructions.

In some embodiments, the indication of ambient pressure change between times t1 and t2 may be determined by measuring and recording ambient pressures p1′ at time t1 and p2′ at time t2 at different geographic locations g2′ and g2″, respectively, wherein g2′ and g2″ are each geographic locations that are nearby the geographic location g2 (see for e.g., FIG. 4 MCDs 102e and 102e′). The different geographic locations g2′ and g2″ may have different ground level elevations e1′ and e1″, respectively. In this embodiment, the nearby ambient pressures p1′ and p2′ can be compensated for their elevation differences using an indication of elevation differences derived from a known or calculated elevation difference between geographic locations g1′ and g2″. Thus, the indication of elevation differences is used in determining the indication of ambient pressure difference change between p1 and p2 at times t1 and t2. The indication of elevation differences is used to remove pressure differences due to elevation differences between locations g2′ and g2″ where the ambient pressures p1′ and p2′ were measured, respectively, at times t1 and t2, respectively.

In other embodiments, methods and systems that determine an indication of ambient pressure changes and/or compensate for changes in ambient pressure between the time t1 of an originating communication and the time t2 that first responders arrive to the general geographic location of the originating communication so elevation of the geographic location where the originating call was made can be accurately estimated may also be accomplished as follows in additional descriptions of variations of embodiments accordance with this disclosure.

Additional embodiments that provide methods or systems for accurately estimating the indication of ambient pressure changes between time t1 and t2 accordance with embodiments of this disclosure may request and/or receive near-real time ambient pressure readings of an ambient pressures at time t1 and t2 directly from a nearby weather station. This can be a very reliable method of obtaining the indication of ambient pressure change (p₂′−p₁′) for time t2 and t1 respectively provided the weather station or other ambient pressure measuring station is nearby the geographic location g1 of the originating communication.

Other embodiments providing methods or systems for determining the indication of ambient pressure changes between time t1 and t2 may use weather predictive computations that estimate the compensated ambient pressure p2_{c} at the, for example, emergency geographic location g2 using one or more weather predictive computational techniques to determine a close estimation of p2 at time t1. In some embodiments the predictive computations may be based on based on ambient pressure measurements requested and/or received from electronic computing devices located near and or nearby of geographic location g1 at times t1 and/or t2. Additionally, temperature, humidity, wind, and other weather conditions near and nearby geographic location g1 may also be used in the weather predictive computations.

In other embodiments, pressure reference stations located about the general geographic area or at specific locations may communicate with the network 104 and provide ambient pressure information data on a continuous time basis for storage in database 108 or server 106. The stored ambient pressure data for various geographic areas or locations may be requested and received from the database for specified times (e.g., times t1 and t2) and used for determining the indication of ambient pressure change (p₂′−p₁′) between time t1 and time t1 or for predictive computational ambient pressure determinations and the like. It is common in many towns and cities for pressure reference stations to already be located at police stations, fire stations, public schools, universities, and on various government buildings making ambient pressure reference stations readily available to incorporate into an embodiment of the present disclosure.

Additionally, in other embodiments, if for example, the ground floor or ground level elevation e1 (shown in FIG. 4) of a fire station or emergency service station 404 is known, and the first responders initiate their trip to the emergency geographic location g1 from the emergency service station 404, then the first responders' MCD 102c can be configured by an application or a user to start at time t1 measuring the ambient pressure p₁′ at the geographic location of the emergency service station 404 (i.e., measure the ambient pressure p₁′ at time t1 at the emergency station 404 where the elevation of the measurement is known) when the initial emergency E911 communication is received. The measured ambient pressure p₁′ can be stored in the responder's or second MCD 102c and/or communicated with other electronic computing devices (i.e., electronic computing devices 102b-102f the server 106 or database 108) in system 100. When the first responders arrive at the emergency geographic location g2 at time t2, the ambient pressure p2 at the ground level geographic location g2 is measured and, for example, stored by the responder's MCD 102c. The ambient pressure p2 measured at the time t2 information may also be communicated to one or more other electronic computing devices in system 100. The indication of ambient pressure difference between the time t1 of the E911 initial communication (and/or the departure time t1′ from the emergency service station 404) and the time t2 of arrival to the emergency geographic location g2 can then be determined by at least one electronic computing device in system 100 in a manner that compensates for the elevation difference between the ground level elevation e2 of geographic location g1 and the ground level elevation e1 of the emergency service station 404. This embodiment requires that the e2 elevation at the geographic location g1 and/or g2 is known or can be received from the database 108 or other geographic altitude map database, elevation map database or data source that provides altitude or elevation data information for geographic locations.

In various embodiments, determining the elevation difference between ground level geographic locations, for example, between geographic locations g2′ and g2″ for use in determining or acquiring an indication of elevation difference between the ground level elevations where ambient pressure p1′ was measured by MCD 102e′ at time t1 and ambient pressure p2′ was measured by MCD 102e at time t2, can be accomplished by retrieving ground level elevations e1′ and e1″ for geographic locations g2′ and g2″ from the database 108 or a third party entity database. (See e.g., FIG. 4 MDC 102e and MDC 102e′). Many ground level elevations of geographic locations have already been determined and stored in databases that are accessible by network 104.

In other embodiments, the ground level elevation of various geographic locations such as the ground level elevation of the emergency location g1, an emergency service station 404, a weather station 410, and the like can often be obtained from an existing altitude map database or elevation map database. Additionally, altitude and elevation map databases can be stored and retrieved electronically from electronic computing devices 102a-102f, server(s) 106 and database(s) 108.

In some embodiments, the ground level elevation differences, such the ground level elevation differences between ground level elevation e2 of the emergency geographic location g1 and the ground level elevation e1 of the emergency service station 404, can be obtained from a positioning system that provides altitude and/or elevation readings with a high accuracy (i.e., with a maximum error of 2 meters). A positioning system that determines altitude readings of specified geographic locations with a high accuracy can be, for example, a high-precision GNSS based or wireless network-based altitude and geographic location positioning system from which embodiments of this disclosure can request and/or receive altitude and/or relative altitude information for one or more geographic locations where ambient pressure measurements were taken at times t1 and t2. As described above, the ground level elevation or altitude measurements of designated geographic locations can be used by the system 100 to further compensate the indication of ambient pressure change between the time t1 and the time t2 compensating ambient pressure measurements p1′ and p2′ taken at no different elevations at times t1 and t2.

Note than may combinations and permutations of the above discussed embodiments of this disclosure can be used to determine an indication of ambient pressure change at the ground level of geographic location g1 (and/or g2) between times t1 and t2; Or to estimate the MCD 102a elevation at the time t1 using the indication of ambient pressure change between the time t1 and time t2 to compensate for the ambient pressure difference between the ambient pressures p1 and p2. For example, embodiments may determine the indication of pressures change between times t1 and t2 and/or compensate for the ambient pressure difference with a weighted average of the indication of pressures change(s) and/or the compensation(s) for the ambient pressure difference(s) obtained by using or combining various methods or system configurations of embodiments described herein.

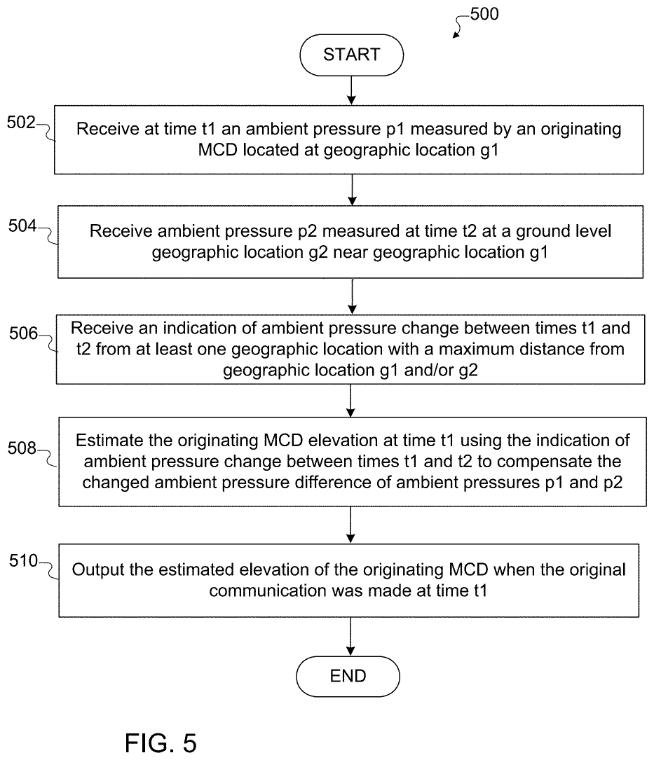

FIG. 5. Illustrates an example method 500 for determining the altitude of an originating communication using pressure change compensation over time according to embodiments of this disclosure. For ease of explanation, the method 500 may be performed using system 100 of FIG. 1 in the geographic map 400 of FIG. 4. For example, some of the operations of FIG. 5 may be performed by any one or more of the electronic computing devices 102a-102f, the server 106 and the database 108. However, method 500 may involve the use of any suitable system(s) and/or device(s) in any suitable environment.

At step 502, method 500 involves receiving an ambient pressure p1 information measured at a time t1 by, for example, a first mobile communication device (MCD) 102a at a geographic location g1. This can include, for example, the first MCD 102a measuring the ambient pressure p1 at an unknown altitude or elevation e0 above a ground level elevation e2 of the geographic location g1 and/or g2. In some methods a user of the first MCD 102a may have initiated an emergency E911 communication to the system 100 (e.g., to an E911 emergency response system). As part of the E911 communication, the first MCD 102a, may be configured to provide ambient pressure p1 taken at time t1 and its geographic location g1 information to the system 100. In other embodiments, after the first MCD 102a initiated the originating communication with the system 100, at least one electronic computing device 102b-102f of the system 100 may be configured to request that at least the ambient pressure p1 and geographic location g1 information be sent by the first MCD 102a to the at least one appropriate electronic computing device 102b-102f in system 100. Upon receiving at least, the ambient pressure p1 and the geographic location g1 information, this information, along with the time t1 of the communication, may be provided to the server 106 or other appropriate electronic computing device 102b-102f (e.g., by wireless or wired transmission).

After the originating communication from the first MCD 102a to the system 100, the first MCD 102a might go off-line or not make any other communications. The inability for the first MCD 102a to continue communicating after the originating communication could be caused by a variety of circumstances that occur in an emergency or event that triggered or caused the originating communication, all of which are beyond the scope of this disclosure. As such, it is important to understand that embodiments of this disclosure can accurately estimate the elevation of an initiating MCD communication only receiving geographic location g1 and the ambient pressure p1 at the time t1 of the initiating MCD communication.

After step 502, emergency personnel such as first responders, police, firemen, or medical personnel may travel to geographic location g1 to provide emergency services. In other circumstances, an automated self-driving vehicle or drone may be sent to the geographic location g1 to survey the situation and measure the ambient pressure p2 at a time t1 in the next step. The first responders or their transportation vehicle may have or include an electronic computing device 102c (i.e., a second MCD).

At step 504, method 500 involves receiving an ambient pressure p2 information measured at time t2 by, for example, the second MCD 102c at geographic location g1 or g2. This may include the geographic location g2 being a location proximate to and at ground level of a building in which the geographic location g1 is located. In some embodiments the geographic locations g1 and g2 may be the same location or within about 25 meters of each other. In other embodiments geographic locations g1 and g2 may be further apart (e.g., up to about 1 km apart). Regardless, of the distance between g1 and g2, if the geographic location of g1 is within a building or structure 402, then geographic location g2 should be at a geographic location having an elevation extremely close to (i.e., within about +/−1 meter) of the ground level elevation Ev1_{glev} elevation of geographic location g1 (or at least a same designated lower floor level of the building or structure 402 at geographic location g1). Geographic locations g1 and g2 are two-dimensional data locations on a map (e.g., latitude and longitude designations, X-Y map designations, navigation system map coordinates) without elevation information.

At step 506, the method 500 involves receiving an indication of ambient pressure change between the time t1 and the time t2 from at least one location within a maximum distance from geographic location g1. This can include, for example, one or more electronic computing devices 102b-102f of system 100 being configured to request and/or receive near-real-time ambient pressure information p1′ and p2′ measured at time t1 and time t2, respectively from, for example, a pressure measuring station 410. In other embodiments, and as discussed above, the indication of ambient pressure change (p2′−p1′) from time t1 to time t2 may be determined in some embodiments wherein the ambient pressures p1′ and p2′ are measured at the same geographic location and elevation, by simply subtracting the ambient pressure p1′ measured at time t1 from the ambient pressure p2′ measured at time t2. The maximum distance from geographic location g1 (and/or g2) that the ambient pressures p1′ and p2′ should be measured is about 10 km in order to maintain accuracy of the estimated elevation output by this method 500. In other words, it is better to measure the p1′ and p2′ ambient pressures closer to the geographic location g1 than further away. Additionally, in various embodiments, the ambient pressure change of p2 from time t1 to time t2 can be deduced computationally by using data received from, for example, a network of weather stations. The network of weather stations may comprise a plurality of weather stations spaced about 10 km apart. In such a network, ambient pressure at any geographic location within the network span can be calculated by, for example, interpolating ambient pressure values measured by various weather stations in the network.

At step 508, the method 500 involves estimating the elevation of the first MCD 102a at the time t1 using the indication of ambient pressure change between time t1 and time t2 to compensate an ambient pressure difference between the ambient pressure p1 and the ambient pressure p2. This may include, for example, the second MCD 102c running an application that estimates the elevation from which the originating MCD communication was made. The elevation estimation in various embodiments is an elevation estimation of the originating MCD's elevation above ground level elevation e1 of geographic location g1 and/or g2. In various embodiments, an electronic computing device(s) in system 100, other than the second MCD 102c, performs the elevation estimating step 508 and then provides the resulting estimation to the second MCD 102c or other computing device in system 100.

At step 510, the method 500 involves outputting the estimated first MCD 102a elevation at the time t1. This may include, for example, the second MCD 102c displaying or otherwise communicating the elevation above the ground level elevation e1 of geographic location or a good estimate of the building floor from which the originating communication was made at time t1. The output can also involve transmission of the first MCD's 102a elevation information and other related information to a display of the emergency personnel's workstation 102b where the original communication from the first MCD 102a was received. The output of the estimated elevation of the originating MCD 102a can be provided to displays, voice outputs, geographic map displays and the like, that are connected to and/or part of the system 100. The output may provide the elevation information in a formation of elevation distance from ground level or as a number of floors associated with the particular building at the geographic location g1. Providing an output of an accurate estimate of the building floor from which an emergency E911 call originated helps eliminate a significant amount of time previously used to search a multiple floor building or other structure to find a person or persons that made the E911 call or needing emergency attention.

Although FIG. 5 illustrates an example of a method 500 for determining the altitude of an originating communication using pressure change compensation over time, various changes may be made to FIG. 5. For example, while shown in a series of steps, various steps in FIG. 5 may overlap, occur in parallel, occur in a different order, or occur any number of times. Also, one or more steps could be added to method 500 and/or one or more steps could be removed from method 500 without deviating from one or more embodiments of this disclosure.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. It should be understood that the drawings and detailed description herein are to be regarded in an illustrative rather than a restrictive manner and are not intended to be limiting to the particular forms and examples disclosed. On the contrary, included are any further modifications, changes, rearrangements, substitutions, alternatives, design choices, and embodiments apparent to those of ordinary skill in the art, without departing from the concepts and scope hereof, as defined by the following claims. Thus, it is intended that the following claims be interpreted to embrace all such further modifications, changes, rearrangements, substitutions, alternatives, design choices, and embodiments.

What is claimed is:

1. A method comprising:
receiving, by one or more processors, an ambient pressure p1 measured at a time t1 by a mobile communication device at a geographic location g1;
receiving, by the one or more processors, an ambient pressure p2 measured at a time t2 within a ground level geographic location g2 near the geographic location g1;
receiving, by the one or more processors, an indication of ambient pressure change between the time t1 and the time t2 from at least one location within a maximum distance from the geographic location g1;
estimating, by the one or more processors, a mobile device elevation of the mobile communication device at the time t1 using the indication of ambient pressure change between time t1 and the time t2 to compensate an ambient pressure difference between the ambient pressure p1 and the ambient pressure p2; and
outputting, by the one or more processors, the estimated mobile device elevation at the time t1.

2. The method of claim 1, wherein receiving the ambient pressure p1 occurs during an initial emergency communication from the mobile communication device.

3. The method of claim 2, wherein the time t2 occurs when a first responder to the initial emergency communication arrives within the ground level geographic location g2.

4. The method of claim 3, wherein the ambient pressure p2 is received from a responder mobile device used by the first responder.

5. The method of claim 1, wherein the indication of ambient pressure change is received from an entity; and
wherein the entity is one of a weather station, an atmospheric pressure reference station, an atmospheric pressure database or at least one other mobile communication device that is stationary between the times t1 and t2.

6. The method of claim 1, wherein the indication of ambient pressure change comprises one of:
i) an entity ambient pressure p1′ at the time t1 and an entity ambient pressure p2′ at time t2; or
ii) an entity indication of ambient pressure difference from the time t1 and the time t2.

7. The method of claim 1, further comprising:
receiving, by the one or more processors, an indication of elevation difference between a ground level elevation e1 associated with an initial geographic location of a responder mobile device at the time t1 and a ground level elevation e2 associated with the geographic location g1;
receiving, by the one or more processors, an ambient pressure p1′ of ground level elevation e1 associated with the initial geographic location of the responder mobile device at the time t1; and
wherein the indication of ambient pressure change between the time t1 and the time t2 further comprises using the indication of elevation difference to further compensate the ambient pressure difference between the ambient pressure p1 and the ambient pressure p2 due to elevation change of the responder mobile device between the time t1 and the time t2.

8. The method of claim 7, wherein the indication of elevation difference is received from an altitude map database.

9. The method of claim 7, wherein the indication of elevation difference is received from a system that provides high accuracy altitude data.

10. The method of claim 7, wherein the ambient pressures p2 and p3 are received from the responder mobile device.

11. A system comprising:
at least one memory configured to store instructions; and
at least one processor coupled to the at least one memory and configured to execute the instructions to:
receive an ambient pressure p1 measured at a time t1 by a mobile communication device at a geographic location g1;
receive an ambient pressure p2 measured at a time t2 within a ground level geographic location g2 near the geographic location g1;
receive an indication of ambient pressure change between the time t1 and the time t2 from at least one location within a maximum distance from the geographic location g1;
estimate a mobile device elevation of the mobile communication device at the time t1 using the indication of ambient pressure change between time t1 and the time t2 to compensate an ambient pressure difference between the ambient pressure p1 and the ambient pressure p2; and
output the estimated mobile device elevation at the time t1.

12. The system of claim 11, wherein the at least one processor is further configured to execute the instructions to receive the ambient pressure p1 during an initial emergency communication from the mobile communication device.

13. The system of claim 12, wherein the time t2 occurs when a first responder to the initial emergency communication arrives within the ground level geographic location g2.

14. The system of claim 13, wherein the ambient pressure p2 is received from a responder mobile device used by the first responder.

15. The system of claim 11, wherein the indication of ambient pressure change is received from an entity; and
wherein the entity is one of a weather station, an atmospheric pressure reference station, an atmospheric pressure database or at least one other mobile communication device that is stationary between the times t1 and t2.

16. The system of claim 11, wherein the indication of ambient pressure change comprises one of:
i) an entity ambient pressure p1′ at the time t1 and an entity ambient pressure p2′ at time t2; or
ii) an indication of entity ambient pressure difference from the time t1 and the time t2.

17. The system of claim 11, wherein the at least one processor is further configured, to execute the instructions, to:
receive an indication of elevation difference between a ground level elevation e1 associated with an initial geographic location of a responder mobile device at the time t1 and a ground level elevation e2 associated with the geographic location g1;
receive an ambient pressure p1′ of ground level elevation e1 associated with the initial geographic location of the responder mobile device at the time t1; and
wherein the at least one processor is further configured to execute the instructions such that the indication of ambient pressure change between the time t1 and the time t2 further comprises the at least one processor to use the indication of elevation difference to further compensate the ambient pressure difference between the ambient pressure p1 and the ambient pressure p2 due to elevation change of the responder mobile device between the time t1 and the time t2.

18. The system of claim 17, wherein the at least one processor is further configured, to execute the instructions, to receive the indication of elevation difference from an altitude map database.

19. The system of claim 17, wherein the at least on processor is further configured, when executing the instructions, to receive the indication of elevation difference from a system that provides high accuracy altitude data.

20. At least one non-transitory computer readable medium containing instructions that when executed cause at least one processor to:
receive an ambient pressure p1 measured at a time t1 by a mobile communication device at a geographic location g1;
receive an ambient pressure p2 measured at a time t2 within a ground level geographic location g2 near the geographic location g1;
receive an indication of ambient pressure change between the time t1 and the time t2 from at least one location within a maximum distance from the geographic location g1;
estimate a mobile device elevation of the mobile communication device at the time t1 using the indication of ambient pressure change between time t1 and the time t2 to compensate an ambient pressure difference between the ambient pressure p1 and the ambient pressure p2; and
output the estimated mobile device elevation at the time t1.
